(19) United States
(12) Patent Application Publication
(10) Pub. No.: US 2011/0178884 A1
(43) Pub. Date: Jul. 21, 2011

(54) TRUSTED STORED-VALUE PAYMENT SYSTEM THAT INCLUDES UNTRUSTED MERCHANT TERMINALS

(76) Inventors: MORDECHAI TEICHER, Hod-Hasharon (IL); Nebojsa Djurdjevic, Oakville (CA); Milos Dunjic, Oakville (CA)

(21) Appl. No.: 12/984,608

(22) Filed: Jan. 5, 2011

Related U.S. Application Data
(60) Provisional application No. 61/296,461, filed on Jan. 19, 2010.

(51) Int. Cl. G06Q 20/00; G06K 19/073

(52) U.S. Cl. 705/16; 235/492; 235/380

(57) ABSTRACT

A stored-value payment system includes trusted cards and untrusted merchant terminals. Security is enhanced by the card receiving an amount of stored value only upon the card confirming that an amount that is at least equal to the received amount is paid by the card at the terminal. The card may provide to the terminal a verifiable payment record for an amount that is calculated by the card by subtracting the value received by the card from the value paid by the card. Further security features may include a terminal certificate that is updated upon settlement and includes a terminal expiration time, and a card time register that is updated upon a payment transaction with an unexpired valid terminal.

### CROSS REFERENCE TO RELATED APPLICATIONS

This application claims the benefit of U.S. provisional patent application 61/296,461 filed on 19 Jan. 2010, which is incorporated herein by reference.

### BACKGROUND OF THE INVENTION

1. Field of the Invention

The present innovation relates to card payment systems, and particularly to consumer card payment systems that store and transact stored-value.

2. Description of Related Art

### Card Payment Systems

Card payment is commonplace and has replaced cash in numerous consumer payments around the world. Card payment methods can be categorized into charge and stored-value.

In charge payment, a card corresponds to a cardholder account that is managed in a server of a financial institution, or a service provider (e.g. mobile operator, payment processor, large retailer, etc.). The account can represent cardholder's debt, and then the card is considered a credit card; or be a bank account, and then the card is considered a debit card; or be a pre-paid account, and then the card is considered a pre paid card.

In stored-value payment, the card is loaded with virtual money (stored-value) purchased using conventional cash or charge, and is used to make payments at compatible merchant stored-value terminals which collect and accumulate the stored-value. The merchant periodically presents the accumulated stored-value for settlement, which ends up with the total monetary value of the accumulated stored-value being added to the merchant's bank account.

Charge payment and stored-value payment can co-exist and, in fact, complement each other. From the point of view of financial institutions that operate payment systems, charge is considered more secure than stored-value, yet more expensive to transact than stored-value. Therefore, a card payment system can be optimized by using stored-value for smaller payments, while charge is used both for larger payments and for purchasing the stored-value loaded onto the card.

A typical charge payment system involves five primary players:
A cardholder who makes payments.
A merchant who receives payments.
An issuer—a financial institution that interfaces with cardholders by providing cards and collecting money for the payments made by card.
An acquirer—a financial institution that interfaces with merchants by providing or approving merchant terminals and reimbursing the merchant by money for the payments received by cards.
A payment organization (AKA payment scheme or payment network), such as Visa and MasterCard, that governs the payment system and coordinates settlements among issuers and acquirers.

Stored-value payment systems involve an additional player: a stored-value issuer that generates stored-value, sells it to cardholders and buys it from merchants. The stored value issuer can be one of the card issuers, or be a dedicated entity specializing in issuance and settlement of stored-value.

### Security and Audit

Payment systems attract fraud, which exposes card issuers to substantial risks. As a result, all payment systems include security mechanisms that combine technological and administrative measures. On top of the security measures, payment systems utilize audit mechanisms that monitor the operation of the payment system, continually verify the effectiveness of the security, and detect security breaches, identify their sources and measure the damage.

Charge payment systems have traditionally implemented on online authorization for each individual charge transaction; clearance, settlement and reporting of each individual transaction; and full accountability as an audit mechanism. This has made charge payment relatively expensive and its operability and reliability dependent on the availability, performance and reliability of electronic communication. When offline operability was a necessity, administrative measures, such as shifting liability from the issuer to the merchant or limiting offline payments to small sums only, provided workable solutions.

The security of stored-value payment is strongly dependent on the technology that is used to store and transact the stored-value. Until the advent of the smart card, all technologies for storing value had been inadequate for securing a general-purse stored-value-based payment system, and therefore stored-value payment was limited to specific applications, where the advantages of card payment justified accepting substantial fraud damages, as was the case with telephone cards and some mass-transit tickets. The audit in such systems was based on comparing the total income from selling stored-value and the total consumption of the respective services, which usually demonstrated substantial yet acceptable damage justified by the respective operational advantages of cashless payment.

### Smart Cards

A smart card combines tamper-resistant chip and advanced cryptography that offer an unprecedented level of security for data storage and exchange. When smart cards reached a sufficient balance between performance and cost, the payment industry has developed and commercialized two smart card payment applications: chip-based charge cards and general-purpose stored-value cards.

Because the majority of charge cards are interoperable across banks and across borders, they tend to adopt industry-wide standards. Europay, MasterCard and Visa then established an industry-wide standard for smart card-based charge payment, which is known as the EMV standard. The EMV standard offers higher security as well as improved offline operability compared to credit and debit cards that employ magnetic stripes.

On the stored-value frontier, that did not exist as a substantial banking product prior to smart cards, various banking endeavors yielded different products, such as Mondex, Proton, MasterCard Cash and Visa Cash. All these products demonstrated sufficient security, yet commercially failed because the need to regularly reload stored-value onto the card via a manual procedure turned off most consumers, while the lack of cost-effective audit solutions and the unclear business case turned off most bankers.

### Prior Improvements in Stored-Value Payment Systems

The present inventor and the present assignee have invented and developed three basic innovations devised to overcome the weaknesses of stored-value smart cards:

U.S. Pat. No. 5,744,787, entitled “System and method for retail”, and U.S. Pat. No. 6,076,075, entitled “Retail unit and a payment unit for serving a customer on a purchase and method for executing the same”, both of which are incorporated by reference as if set forth herein in their entirety, teach a Charge & Change mechanism. Under Charge & Change, a card and a payment terminal include both charge and stored-value functionalities; larger payments are automatically referred to charge, while smaller payments are either paid by stored-value from the card (if the appropriate stored-value amount is available), or a minimum charge amount (for example, $25) is charged to the card, and the remainder ($25 less the purchase price) is returned by stored-value from the payment terminal to the card. The advantage of Charge & Change is in eliminating the stored-value loading burden for cardholders while also eliminating the cost of processing charge transactions that are smaller than the minimum charge amount.

U.S. Pat. Nos. 6,119,946 and 6,467,685, both entitled “Countable electronic monetary system and method” and incorporated by reference as if set forth herein in their entirety, add a functionality of cost-effective audit for stored-value, through representing stored-value by serialized electronic coins of various denominations. Each stored-value transaction involves coins that move between the card and the merchant terminal, often in both directions. The coins are systematically sampled at a central point, which makes fake stored-value quickly and effectively detectable, measurable and back-traceable.

U.S. Pat. No. 6,065,675, entitled “Processing system and method for a heterogeneous electronic cash environment”, also incorporated by reference as if set forth herein in its entirety, teaches the seamless integration of a stored-value system into the operational modes and business models of existing credit and debit payment systems.

The combination of the three improvements above overcomes the past deficiencies of stored-value micropayment/low-value payment described above. However, the migration of a huge installed base of credit and debit cards to accommodate also stored-value micropayments still proves to be a major operational and commercial challenge.

### The Need for Further Improvement of Stored-Value Payment

EMV charge (credit and debit) systems gain traction in more and more markets. Other charge mechanisms are also offered by banking and non-banking institutions. A market that migrates to EMV charge payment upgrades the cardholder cards to smart cards and the merchant terminals to terminals that can interface with smart cards. Under the current practices of credit and debit payment, most of the security burden lies on the card side, while the merchant terminal serves primarily as a container and conduit of transaction information, and does not represent substantial risk to the system. Accordingly, while some merchant terminals feature highly-secure hardware, cost considerations push many other merchant terminals to be based on simpler and less expensive designs thus becoming less secure which, as indicated above, is acceptable for EMV payment or equivalents thereof.

The situation is different when considering stored-value payment. Traditionally, stored-value payment has been considered sufficiently secure only if the storage and transfer of stored-value were handled by and between secure chips known as a cardholder's smart card and a merchant's secure application module (SAM) that is typically a smart card chip packaged similar to the mobile telephone SIM and inserted into a dedicated slot in the merchant terminal. For years, many merchant terminals included a SAM slot, as a provision for accommodating stored-value applications. However, since stored-value applications lagged behind plans and expectations, many merchant terminals deployed in the market have no SAM slot.

Accordingly, under the traditional approach of including a SAM in merchant terminals for storing and transacting stored-value, the addition of stored-value functionality to an EMV credit/debit system requires not only upgrading the card's and merchant terminal's software/firmware, but also replacing or physically upgrading many merchant terminals to include a SAM slot, and deploying and managing the SAMs. This highly increases the threshold for affording stored-value implementation, and may even render such implementation commercially-impractical.

There is therefore a need for, and it would be highly advantageous to have, solutions for a sufficiently-secure stored-value payment system that affords utilization of merchant terminals that do not count on SAM security.

### SUMMARY OF THE INVENTION

The present innovation seeks to provide systems and functionalities for affording the use of untrusted merchant terminals within a secure stored-value payment system.

### DEFINITIONS

By “cardholder” or “user” is meant a consumer making payment to a merchant.

By “merchant terminal” or “terminal” is meant a merchant device for electronically accepting payment.

By “smart card” or “card” is meant a secure, chip-based portable device that is used for making payment at a merchant terminal. The card may have any form factor, such as a traditional plastic card, key-fob, sticker/tag, microSD card, or mobile telephone. The card communicates with a merchant terminal via contact of contactless interface.

By “issuer” is meant an institution that supplies cards to cardholders and collects money from cardholders for electronic payments made by their card.

By “charge transaction” or “charge” is meant a credit, debit or prepaid payment transaction that charges an account remote from the card.

By “stored-value” is meant an electronic representation of money that can be loaded onto and stored on cards and transferred to merchant terminals for payments.

By “electronic purse” is meant a secure area in a smart card chip devised to store stored-value.

By “secure application module” or “SAM” is meant a chip-based secure component that is included in a merchant terminal for storing stored-value and for transacting stored-value with merchant terminals. Generally speaking, the present innovation focuses on merchant terminals that store and transact stored-value without having a SAM or without using a SAM even if it physically exists in the terminal, and such terminals will sometimes be referred to as “SAM-less” terminals.

By “untrusted merchant terminal” or “untrusted terminal” is meant a merchant terminal that is initially secure but is not protected against copying or changing its digital content via physical tampering. The designation of a merchant terminal as untrusted is stored-value issuer-specific and subjective, and does not imply that the terminal is indeed easy to access and compromise.

By “Charge & Change” or “C&C” is meant a payment transaction between a merchant terminal and a smart card that involves both a charge transaction and a transfer of stored-value from the merchant terminal to the card, as taught by U.S. Pat. Nos. 5,744,787 and 6,076,075, both incorporated by reference as if set forth herein in their entirety. For example, a Charge & Change transaction for paying $P is made by charging to the card an amount $X that is larger than $P, and transferring a stored-value amount of $X-$P as change from the terminal to the card.

By “electronic coins” or “coins” is meant electronic representation of stored-value, each coin having a denomination and a serial number. The coins are devised to provide an effective system-level audit mechanism, as demonstrated, for example, by U.S. Pat. Nos. 6,119,946 and 6,467,685, both incorporated by reference as if set forth herein in their entirety.

By “digitally-verifiable” or “verifiable” data is meant data (such as a certificate or transaction record) whose authenticity can be verified via cryptographic methods known in the art such as encryption/decryption, message authentication code and/or digital signature verification.

The term “net amount” generally relates to the monetary value of stored-value transferred from a merchant terminal to a payment card or from a payment card to a merchant terminal. In the specific case of using electronic coins for the representation and transfer of stored-value (see U.S. Pat. Nos. 6,119,946 and 6,467,685), electronic coins may be transferred between a payment card and a merchant terminal in both directions within a single stored-value transaction, and the net amount is the balance of such transfers; for example, if a 4¢ coin is moved from the payment card to a merchant terminal and a 1¢ coin is moved from the merchant terminal to the payment card, then the net amount is of 3¢ moving from the payment card to the merchant terminal.

### Threat Analysis

The following analysis depicts sources and scenarios of criminal threats that the present innovation comes to eliminate or diminish. The analysis is not necessarily complete, and other threats may exist in the present context, some of which may also be overcome or diminished by the present innovation. Also, some threats may be reduced but not eliminated by the present innovation.

### Scope of Threats Covered by the Present Innovation

The merchant terminal, as originally supplied to a merchant, is presumed trusted by the stored-value issuer, and its initial security is presumed similar to that of the SAM with respect to attacks from cards or from remote computers through communication networks. For the sake of the present discussion, the security threats with respect to terminals that are not physically stolen or tapped, will be considered satisfactorily answered by prior security solutions, and will not be discussed herein.

Also, the merchant terminal is assumed to be certified, and considered sufficiently secure, for making charge (credit and/or debit and/or pre-paid) transactions, preferably but not necessarily under the EMV standard, in both online and offline modes.

The threats of interest are the added threats that are implied by the lack of the tamper protection offered by a SAM. A SAM prevents physical access to its digital content, which typically includes configuration and transaction data, program code and cryptographic keys, all of which become exposed in a SAM-less terminal to a proficient criminal who gets physical access to the merchant terminal.

It is not necessarily implied that there is no SAM included in the merchant terminal, but just that there is no reliance on the inherent tamper resistance of a SAM, even if a SAM or any other tamper-resistant chip or circuitry is present within a merchant terminal.

### Assumptions Regarding the Payment System

It is assumed that there is a large number of merchant terminals that regularly serve cardholders for payment. Merchants generally protect their terminals against theft and tapping, and the great majority of the terminals is presumed uncompromised. A cardholder is assumed to use his card for making payments at a plurality of terminals, of which most of the terminals are uncompromised.

### Criminals, Criminal Patterns and Countermeasures

The pertinent threats involve physical access to a terminal in order to access and manipulate its digital content. Physical access requires either a theft of a terminal, or physically tapping an operative terminal. The criminals can be a thief, a merchant, a merchant's employee, and a tapper of an easily-accessible terminal that is placed in a public area such as a vending machine or a parking meter.

The criminal patterns can include:
Profiting from presenting fake stored-value for settlement
Profiting from using fake stored-value for making purchases
Profiting from selling fake stored-value to others
Hacking the system for personal satisfaction.

Countermeasures typically aim at:
Physically protecting terminals and their hardware against tampering, and/or disabling tampered terminals
Deterring criminals by effectively identifying compromised terminals and misused cards
Minimizing potential profits, thus rendering an attack financially unattractive
Containing and measuring potential damage
Quickly recovering from criminal incidents.

### Intrinsic Countermeasures Offered by Conventional Systems and Prior Improvements

Merchant terminals are usually physically protected against theft and tapping. This leaves the great majority of terminals uncompromised.

Additional hardware provisions that disable stolen or tampered merchant terminals and erase their memories can further reduce the risk and motivation under discussion. Adding a secure unique-ID chip to a merchant terminal and linking the merchant terminal software to that chip may effectively prevent cloning of stolen or tapped merchant terminal.

Employing a Charge & Change mechanism (U.S. Pat. Nos. 5,744,787 and 6,076,075) for loading stored-value, limits the amount that can be spent by stored-value to a small value (say, $25-50), which highly diminished the criminal motivation related to using or selling fake stored-value for making purchases.

Employing coins for auditing stored-value (U.S. Pat. Nos. 6,119,946 and 6,467,685) will quickly and effectively spot payment cards and terminals that supply fake stored-value, hence highly reduce the feasibility and motivation for profiting from settling, using or selling fake stored-value.

The present innovation seeks further improvement on top of the above countermeasures, with focus on the additional threats that are specific to merchant terminals that are either SAM-less or include a SAM but do not count on SAM security.

### Synopsis

The present innovation comes to reduce the motivation for criminal attacks on a SAM-less stored-value payment system, and minimize the stored-value issuer's exposure, on top and beyond the intrinsic countermeasures reviewed above.

In its broadest sense, preferred embodiments of the present innovation impose new security roles for the payment card, for supervising the particulars of a transaction to ensure that the transaction is not abused by the terminal and/or checking the validity of a merchant terminal. For the sake of the present innovation, the payment card is presumed to be a tamper-proof smart card that is uncompromised and trusted by the stored-value issuer.

According to a first aspect, the card confirms the particulars of each payment transaction, and prevents illegitimate infusion of stored-value into the card, by ensuring that a net amount of stored-value is added to the card only upon a successful completion of a charge transaction that is larger than that net amount.

According to a second aspect, if the stored-value is composed of serialized digital coins of several denominations, the card confirms that the total value of coins flowing into the card is smaller than either the total value of coins flowing from the card to the terminal (if no charge transaction is involved in the stored-value payment transaction) or the sum of the total value of coins flowing from the card to the terminal and the charge amount (if a charge transaction is included in the stored-value payment transaction).

It will be noted that the term “card confirms” in the first and second aspects above means that either the card calculates and executes all stored-value related operations on the card based on a payment request from the merchant terminal, or that all or some of the stored-value related calculations and operations are initiated by the terminal, and the card monitors such operations and checks their value and will deny or abort an attempt for a stored-value transfer that violates the conditions of any or both of the first and second aspects above. When a payment transaction involves a charge operation, it is presumed that the card is aware of the charge amount via the charge payment protocol in both online and offline scenarios.

According to a third aspect, a terminal certificate is issued by the stored-value issuer, or by a trusted service provider, to each merchant terminal upon successful settlement. The certificate includes at least the terminal ID and an expiration time that equals the next expected settlement time plus a safety margin. For example, if the subsequent settlement is expected in 24 hours, the certificate may include an expiration time of 48 hours from the current settlement time. The certificate is digitally-verifiable, i.e. digitally-signed and/or encrypted by the terminal certificate issuer, in a way that it is readable and verifiable by any valid card, yet is impractical to fake by an unauthorized party. The card checks the certificate expiration time and compares it with the card time, and aborts the transaction if the card time is later than the expiration time.

According to a fourth aspect, the card receives from the terminal a terminal time, and aborts a transaction if the terminal time is smaller than the card time or larger than the terminal's certificate expiration time. If the card has no built-in real-time clock, as is the case with plastic smart cards, the card time is stored in and read from a nonvolatile register within the smart card's chip and is advanced upon purchase according to the terminal time, provided that the terminal certificate has been validated, and the terminal time is greater than the card time and not greater than the terminal's expiration time.

According to a fifth aspect, toward the conclusion of a successful stored-value payment at a merchant terminal, the card calculates the transaction value according to the actual flow of stored-value and charge known to the card, and issues a payment record for that transaction value, digitally-signed and/or encrypted by the card. The payment record is sent to and kept by the merchant terminal, and is collected by the merchant terminal with other payment records received by the terminal, as a basis for settlement at the end of the business cycle.

It will be noted that the payment record issued and signed by the card can be of any form that is readable and verifiable by the stored-value issuer. For example, it can be a file, or a line item within the terminal's transaction record, in which case the digital signature or message authentication code provided by the card forms part of the line.

There is thus provided, in accordance to preferred embodiments of the present innovation, a method executed by a card while making a stored-value payment transaction at a merchant terminal, the method including: (a) interfacing with the merchant terminal; and (b) accepting a positive first amount of stored-value into the card only upon confirming that a corresponding second amount, that is not smaller than the first amount, is paid by the card at the merchant terminal. The second amount may be paid by charge.

If the stored-value is represented by coins and each coin has a denomination and a serial number, then, if no charge transaction is involved, then the payment transaction may consist of a first group of zero or more coins designated to flow from the merchant terminal to the card, and a second group of one or more coins designated to flow from the card to the merchant terminal, in which case the first amount equals the first group's total value and the second amount equals the second group's total value. If a charge transaction is also included, then the first amount equals the first group's total value; and the second amount equals the sum of the second group's total value, and the charge transaction's value.

The method may also include providing to the merchant terminal a verifiable payment record for a payment amount that is calculated by the card by subtracting the first amount from the second amount.

The method may further include verifying the validity of a terminal certificate received from the merchant terminal, and aborting the stored-value payment transaction if the verifying is negative; and, if the verifying is positive: (a) reading a card time from a time register of the card, (b) receiving a terminal time from the merchant terminal, (c) retrieving a terminal expiration time from the terminal certificate, checking whether the terminal time is both not smaller than the card time and not greater than the terminal expiration time, and aborting the payment transaction if the checking is negative. However, if the checking is positive, then the method further includes setting the card time in the time register according to the terminal time.

Preferred embodiments of the present innovation also include a payment card that includes: (a) a microprocessor; (b) a terminal interface for selectably interfacing with a selectable merchant terminal for making a payment transaction; (c) a charge module cooperating with the microprocessor for charging a remote account; and a stored-value purse for storing stored-value, cooperating with the microprocessor for moving selectable amounts of stored-value between the payment card and a merchant terminal via the terminal interface, wherein the payment card is operative, while interfacing with a selected merchant terminal, to accept a positive first amount of stored-value only upon confirming that a corresponding second amount, that is not smaller than the first amount, is paid by the payment card at the selected merchant terminal. In a payment transaction that includes both charge and stored-value transactions, the first amount is a net amount of stored-value received by the stored-value purse, and the second amount is paid by the charge module. If the payment card is operating within a coin-based stored-value system in a payment transaction that does not include a charge transaction, the payment transaction then consists of: a first group of zero or more coins designated to flow from the merchant terminal to the purse, and a second group of one or more coins designated to flow from the purse to the merchant terminal; and then the first amount equals the first group's total value and the second amount equals the second group's total value. In a payment transaction that includes both charge and stored-value transactions, the first amount is the total value of coins received by the stored-value purse from the selected merchant terminal, and the second amount equals the sum of: a charge amount paid by the charge module at the selected merchant terminal, and the total value of coins transferred from the stored-value purse to the selected merchant terminal. The card may be further operative to calculate a payment amount by subtracting the first amount from the second amount, and provide to the selected merchant terminal a verifiable payment record for the payment amount.

The card may include a card time register and be operative to: verify the validity of a terminal certificate received from the selected merchant terminal; abort a transaction if the verify is negative; and, if the terminal certificate is found valid, then the terminal reads a card time from the card time register, receives a terminal time from the selected merchant terminal, retrieves a terminal expiration time from the certificate, checks whether the terminal time is both not smaller than the card time and not greater than the terminal expiration time, and aborts the transaction if the check is negative. If the check is positive, the card is operative to set the card time in the card time register according to the terminal time.

Preferred embodiments of the present innovation also include a merchant terminal that includes: (a) a card interface for communicating with payment cards; (b) a network interface for interfacing, via a network, with a stored-value processing server; (c) a terminal certificate register for storing a terminal certificate that includes a terminal ID and a terminal expiration time; and (d) a processor configured to: (i) during settlement with the stored-value processing server, renew the terminal certificate stored is the terminal certificate register, and (ii) during interfacing with a card, present the terminal certificate to the card.

Preferred embodiments of the present innovation also include a method for operating a stored-value processing server, including: interfacing with a merchant terminal; receiving terminal identification from the merchant terminal; and if no irregularities are identified with respect to the terminal identification, then issuing a fresh terminal certificate for the merchant terminal, the terminal certificate including at least the terminal identification and a terminal expiration time, and providing the fresh terminal certificate to the merchant terminal. If and only if no irregularities are identified, then the method also includes executing stored-value settlement with the merchant terminal.

### BRIEF DESCRIPTION OF THE DRAWINGS

The present innovation will be understood and appreciated more fully from the following detailed description, taken in conjunction with the drawings in which:

FIG. 1 is a simplified block diagram describing a payment system according to a preferred embodiment of the present innovation.

FIG. 2 is a simplified block diagram describing a terminal certificate.

FIG. 3 is a simplified block diagram illustrating permutations of card time, terminal time and terminal expiration time.

FIG. 4 is a simplified flowchart describing the operation of a card upon interfacing with a merchant terminal.

FIG. 5 is a simplified flowchart describing a payment transaction according to a preferred embodiment of the present innovation.

FIG. 5A is a simplified flowchart describing a payment transaction according to another preferred embodiment of the present innovation.

FIG. 5B is a simplified flowchart describing a selectable payment and/or loading transaction at a merchant terminal according to a preferred embodiment of the present innovation.

FIG. 5C is a simplified flowchart describing a selectable payment transaction at merchant terminal or a secure loading transaction at a loading terminal according to a preferred embodiment of the present innovation.

FIG. 6 is a simplified block diagram illustrating an exemplary content of a stored-value payment record.

FIG. 7 is a simplified flowchart describing a settlement procedure according to a preferred embodiment of the present innovation.

### DETAILED DESCRIPTION OF THE INVENTION

### The Payment System

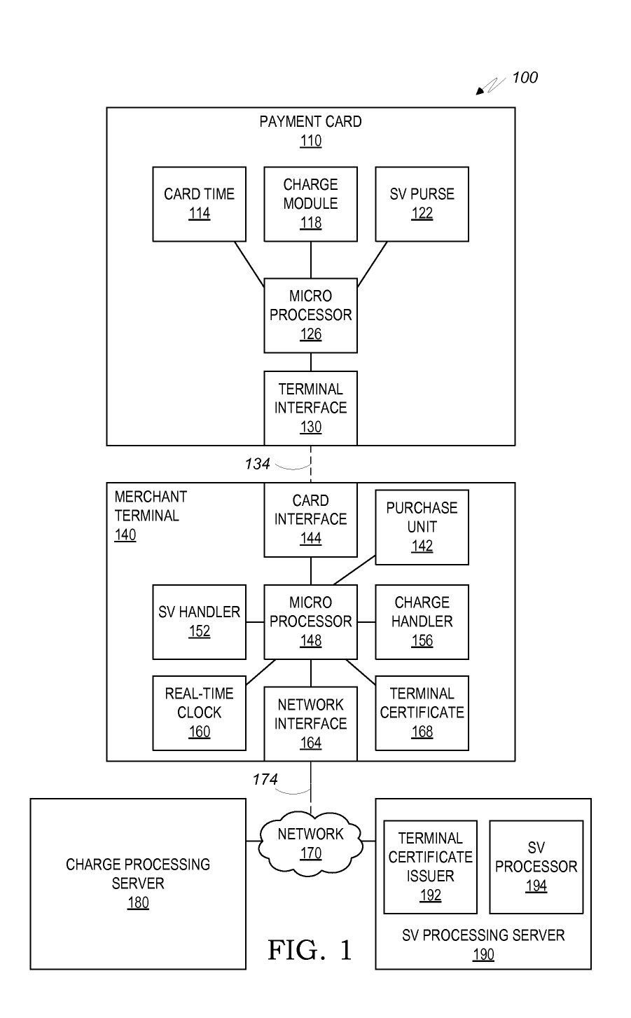

Reference is made to FIG. 1 that describes a payment system 100 according to a preferred embodiment of the present innovation. The system includes payment card 110 that is one of a plurality of payment cards, merchant terminal 140 that is one of a plurality of merchant terminals, charge processing server 180 that handles credit and/or debit processing, and stored-value processing server 190 that manages and supervises all aspects related to stored-value generation, settlement, audit and security.

Payment card 110 is a smart card that includes a secure chip for storing and processing data, and can be packaged in any portable form factor, such as a plastic card, a key fob, or a mobile telephone. Preferably but not necessarily, payment card 110 is a multi-application card certified under the EMV standard. Card microprocessor 126 manages communication and processing functionalities of payment card 110, including all or part of card time register 114, charge module 118 and stored-value purse 122 described below, with the remainder optionally running on optional dedicated hardware components described below.

Charge module 118 includes account and cardholder data, cryptographic keys and transaction parameters for enabling payment card 110 to perform credit and/or debit transactions in cooperation with merchant terminal 140 and charge processing server 180, as known in the art of credit and debit payment. Preferably but not necessarily, payment system 100 allows payment card 110 to make both online and offline charges at merchant terminal 140, under provisions and rules known in the art.

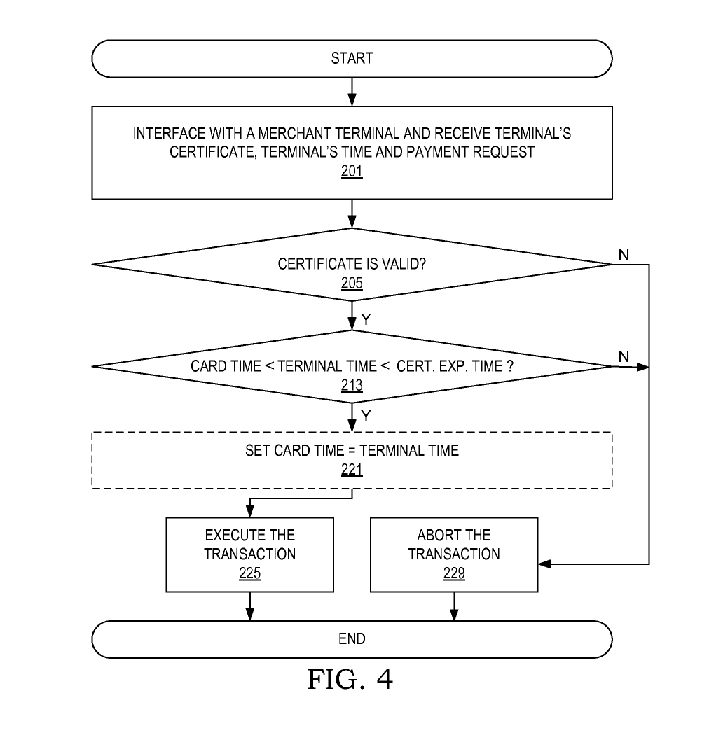

Card time register 114 provides card microprocessor 126 with the last time known to the payment card 110. In some preferred embodiments, such as when payment card 110 is embedded within a mobile telephone, card time register 114 can be a real-time clock. On the other hand, in the case of the form factor of a common plastic card, the card has no power supply of its own which makes a real-time clock unfeasible. In such cases, card time register 114 is a nonvolatile memory storage device, and is adjusted upon valid payment transaction according to the current time of a merchant terminal, as will be elaborated with reference to FIG. 4 below.

Stored-value purse 122 preferably includes a secure storage device for storing stored-value, cryptographic keys for validating stored-value transaction data and the terminal certificate described below, transaction log information, software for the stored-value related operations of card microprocessor 126, and possibly an autonomous controller for running stored-value specific or cryptographic calculations. In some embodiments, card time register 114 may be implemented as part of stored-value purse 122.

Terminal interface 130 allows card microprocessor 126 to communicate with merchant terminal 140 during payment transactions. If payment card 110 has no power supply of its own, terminal interface 130 also obtains electrical energy from merchant terminal 140 for energizing payment card 110 during a transaction. Terminal interface 130 can be, for example, a standard smart card contact interface (e.g. under ISO 7816), a contactless electromagnetic interface that uses electromagnetic signals for data exchange and possibly also for energizing payment card 110 via electromagnetic induction (e.g. under ISO 14443), or an infrared or Bluetooth interface, if payment card 110 is self-energized.

Merchant terminal 140 interfaces with payment card 110 for payment transactions. The payment can be for purchase of goods or service; however, in the context of the present disclosure, also a pure load transaction, that ends up with loading a stored-value amount into stored-value purse 122 and charging that amount (possibly while adding applicable fee) through charge module 118, will be considered a payment transaction. Card interface 144 interfaces via link 134 with terminal interface 130 of payment card 110, using a matching technology, such as standard smart card contact interface, a contactless electromagnetic interface, or a Bluetooth or infrared interface. If payment card 110 is not self-energized, card interface 144 is also used for energizing payment card 110 during transactions.

Purchase unit 142 determines the payment amount to be paid by the card. Examples for purchase unit 142 include a cash register connected to a scanner; an automatic vending device such as a vending machine, a parking meter, or a pay phone; or a keypad for receiving a payment amount from a human operator. Purchase unit 142 can be an integral unit of merchant terminal 140, or can be external to the physical structure of the other blocks of merchant terminal 140 and communicate with terminal microprocessor 148 via a communication link.

Terminal microprocessor 148 connects with the other units of merchant terminal 140 to execute computing and communication tasks of merchant terminal 140. Charge handler 156 is preferably a nonvolatile memory that includes software and credentials of merchant terminal 140 for executing, by terminal microprocessor 148, credit and/or debit transactions with charge module 118 of payment card 110 on the one side, and with charge processing server 180 on the other side.

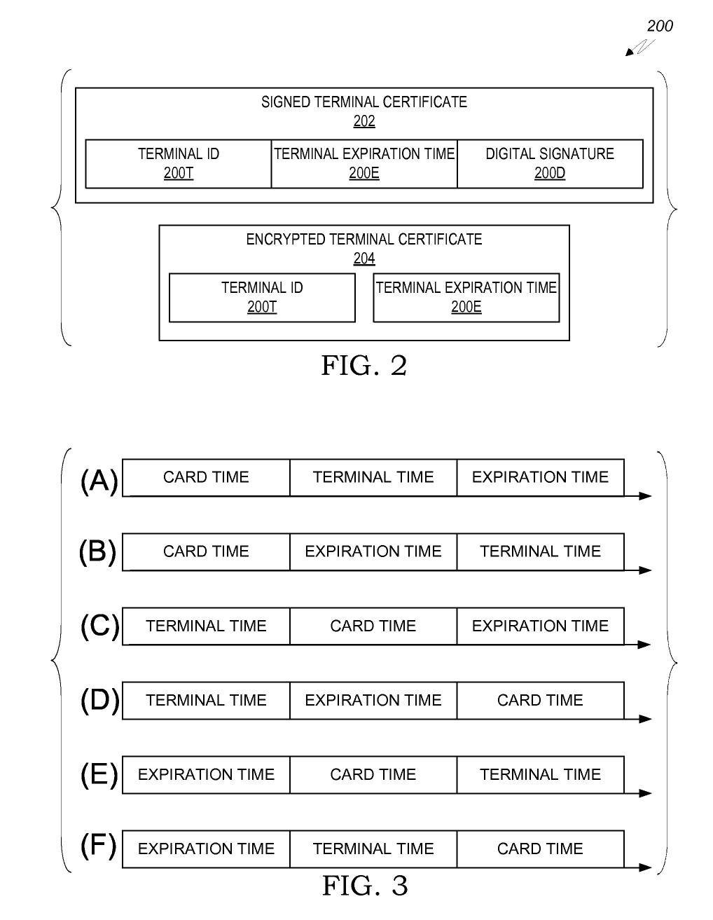

Stored-value handler 152 is preferably a nonvolatile memory that includes software and credentials of merchant terminal 140 for executing, by terminal microprocessor 148, stored-value transactions with stored-value purse 122 of payment card 110 and for settling stored-value with stored-value processor module 194 of stored-value processing server 190. Stored-value transactions can be performed according to a variety of stored-value schemes, as will be discussed below. Real-time clock 160 provides terminal microprocessor 148 with data of the current date and time, as an input for reporting and operational applications. Terminal certificate register 168 (see also FIG. 2) stores a terminal certificate that is received from terminal certificate issuer module 192 of stored-value processing server 190 upon successful settlement, and is checked by payment card 110 as will be described below with reference to FIG. 4. Network interface 164 allows merchant terminal 140 to communicate with charge processing server 180 and stored-value processing server 190 via network 170.

Charge processing server 180 is a server of a financial institution or a dedicated transaction processor, connecting merchant terminal 140 with the respective acquirers and issuers, for customary credit and/or debit authorization and settlement transactions.

Stored-value processing server 190 interfaces with merchant terminal 140 for stored-value related settlement and services, mostly executed by stored-value processor module 194 that includes the data storage and processing hardware, as well as programs and credentials, for securely handling stored value transfers with merchant terminal 140 and for accounting for such transfers, according to the particulars of the stored-value payment system used. In a preferred embodiment of the present innovation of an improved payment system that employs Charge & Change (U.S. Pat. Nos. 5,744,787 and 6,076,075), coin-based audit (U.S. Pat. Nos. 6,119,946 and 6,467,685) and branded settlement (U.S. Pat. No. 6,065,675), stored-value processor module 194 also manages priming of merchant terminal 140 with stored-value during successful settlement, checking and refreshment of coins, and settlement aggregation according to card brands.

Terminal certificate issuer module 192 issues, upon successful settlement with merchant terminal 140, a fresh certificate to be stored in terminal certificate register 168. The certificate includes the terminal ID and an expiration time that equals the next expected settlement time plus a predefined safety margin. For example, if the subsequent settlement is expected in 24 hours, the certificate may include an expiration time of 48 hours from the current settlement time. The certificate is digitally-verifiable by any valid card, and is cryptographically protected by techniques known in the art of digital security, so that it is impractical, or at least excessively expensive, to fake by an unauthorized party. It is presumed, however, that the certificate of a compromised merchant terminal 140 is readable and can be copied to clones of that terminal but without extending the certificate's expiration time.

Network 170 is either a dedicated financial network or a public network such as the Internet or a mobile network. Network 170 serves to selectably connect merchant terminal 140 with charge processing server 180 and stored-value processing server 190.

Link 134 is temporarily established between payment card 110 and merchant terminal 140 upon a cardholder presenting payment card 110 at merchant terminal 140 for payment, and allows data communication between card microprocessor 126 and terminal microprocessor 148. In some cases, link 134 also supplies electrical energy from merchant terminal 140 to payment card 110. The technology of link 134 matches the technology of terminal interface 130 and card interface 144, presented above.

Link 174 selectably connects merchant terminal 140 with charge processing server 180 for authorizing and settling credit and/or debit payments, and with stored-value processing server 190 for stored-value related transactions via network 170. Preferably but not necessarily, merchant terminal 140 can operate also in offline mode, and then link 174 can be disconnected or idle. Link 174 can employ any communication technology that matches that of network interface 164 and network 170.

### The Terminal Certificate

FIG. 2 describes two preferred embodiments, signed terminal certificate 202 and encrypted terminal certificate 204, of terminal certificate 200 that is generated by terminal certificate issuer module 192, stored in terminal certificate register 168 and checked by card microprocessor 126. Signed terminal certificate 202 is a plain text string that includes three fields: (1) terminal ID 200T that uniquely identifies merchant terminal 140 to stored-value processing server 190 upon settlement and possibly also to payment card 110, upon payment, for transaction logging purpose; (2) terminal expiration time 200E that is determined by stored-value processing server 190 according to the next expected settlement time plus, preferably, a safety margin for the case that the settlement is reasonably delayed, and (3) digital signature 200D that signs terminal ID 200T and terminal expiration time 200E and is verifiable by card microprocessor 126. Thus, the content of signed digital certificate 200 is clear and can be read by anyone, but the digital signature 200D prevents unauthorized generation of fake certificates.

Encrypted terminal certificate 204 includes the data of terminal ID 200T and terminal expiration time 200E as in signed terminal certificate 202, in encrypted form. The certificate is preferably generated by terminal certificate issuer module 192 and provided to a merchant terminal 140 upon settlement and stored in terminal certificate register 168 in its encrypted form. When presented to any payment card 110 upon payment, the card receives and decrypts the encrypted digital certificate 204 using the appropriate cryptographic keys that are shared between the cards and terminal certificate issuer module 192 (preferably using asymmetric keys, where the private key is kept by terminal certificate issuer module 192 while the public key is included in stored-value purse 122). Thus, the content of encrypted terminal certificate 204 is stored in terminal certificate register 168 of merchant terminal 140, but its encryption makes it illegible to anyone who hacks merchant terminal 140 and further, generation of a fake certificate is impractical.

The purpose of the terminal certificate 200 is to limit the damaging operation that can be caused by a stolen terminal to typically a couple of days, after which the certificate will expire, which will render the terminal inoperative because cards will abort transactions with the expired terminal (see FIG. 4 below). A stolen terminal is likely to be identified and reported to stored-value processing server 190, and then terminal certificate issuer module 192 will not extend its certificate any more. Thus, even if a stolen terminal is cloned along with its certificate, any activity by all clones will cease on the certificate expiration time.

If a terminal is tapped and hacked without being stolen, such compromised terminal will initially not be identified and reported, and its certificate will be normally renewed, which will allow further exploitation of that terminal. However, an effective audit mechanism, such as the coin-based audit of U.S. Pat. Nos. 6,119,946 and 6,467,685, will effectively spot the tapped terminal upon settlement, and not only that its certificate renewal will be suspended, but also the terminal will be confiscated and the criminal that has tapped the terminal may be identified.

### Time Units and Clock Accuracy

The present discussion involves three time values: the card time of card time register 114, terminal time retrieved from the terminal's real-time clock 160, and expiration time obtained from verifying the terminal certificate 200. The three time values always include the date, and may be expressed with different time units. For example, the terminal time may be expressed with one second resolution, the card time may use one hour resolution, and the terminal expiration time may be expressed with a resolution of one day (i.e. expiration time is actually expiration date). Comparing times under such circumstances is common in the art. Also, it is presumed that time zones and daylight saving times are taken into account as appropriate and will not be further discussed herein.

Clock accuracy may be also affect time comparisons. This may be taken into account by introducing a “grace period” to time comparison criteria, say of one minute. Such predefined margins may be included in any time comparison-based decision, and will not be further discussed herein.

FIG. 3 illustrates six scenarios A-F that can face a card when interfacing a merchant terminal during payment, based on comparing the card time of card time register 114, terminal time retrieved from the terminal's real-time clock 160, and expiration time obtained upon verifying the terminal certificate 200. Scenario (A) is proper for normal operation, since the card time is expected to be substantially equal to the terminal time if the card time register 114 is a real time clock, and be earlier than the terminal time if card time register 114 is a nonvolatile storage register updated in a previous purchase transaction; also, the terminal time is expected to be not later than the expiration time. Each of scenarios (B)-(F) presents an anomaly and will preferably cause abortion of the transaction by the card, because in scenarios (B), (D), (E) and (F) the terminal certificate has expired with respect to the card and/or terminal time, and in (C), (D) and (F) the terminal time is earlier than the card time, which is not expected under normal legitimate conditions.

### Checking Terminal Certificate Validity and Updating Card Time

FIG. 4 describes a procedure, executed by payment card 110 upon payment, for checking the validity of a merchant terminal. In step 201a payment card 110 is presented by the cardholder at merchant terminal 140 for making a payment transaction; the card and the terminal communicate via terminal interface 130, link 134 and card interface 144, and the card receives the terminal certificate 200 that is retrieved by the terminal from terminal certificate register 168. Also, the card receives from the terminal the terminal time that the terminal retrieves from real-time clock 160, and a payment amount request determined by purchase unit 142.

In step 205 the card checks the validity of terminal certificate 200; for example, if signed terminal certificate 202 is used, digital signature 200D is checked to verify the authenticity of terminal ID 200T and terminal expiration time 200E; if encrypted terminal certificate 204 is used, it is decrypted by payment card 110 to retrieve terminal ID 200T and terminal expiration time 200E. If the certificate is found invalid, then the transaction is aborted in step 229, and the card will not further cooperate with the terminal.

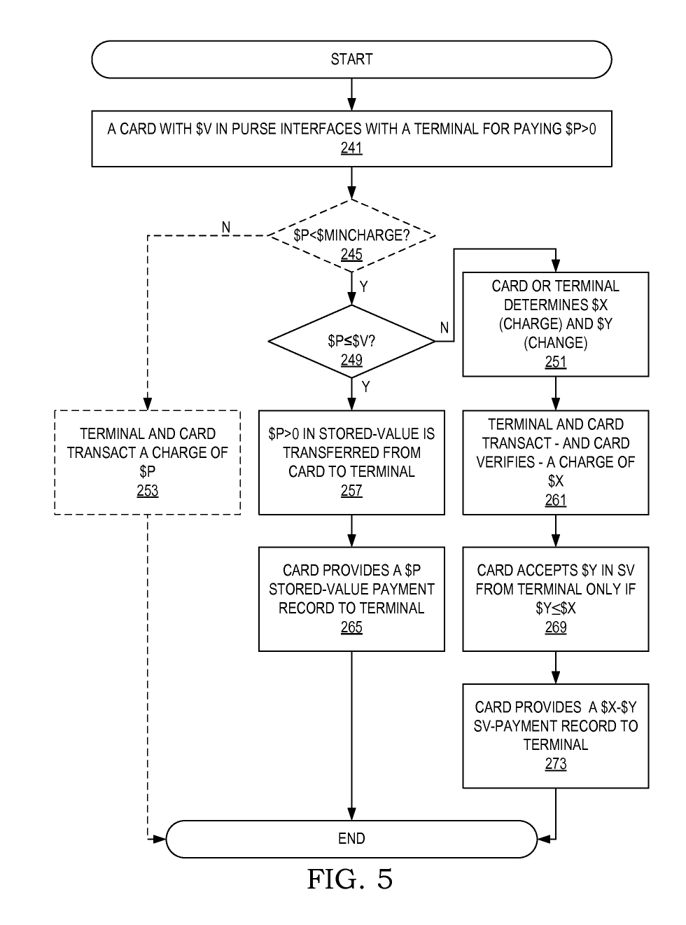

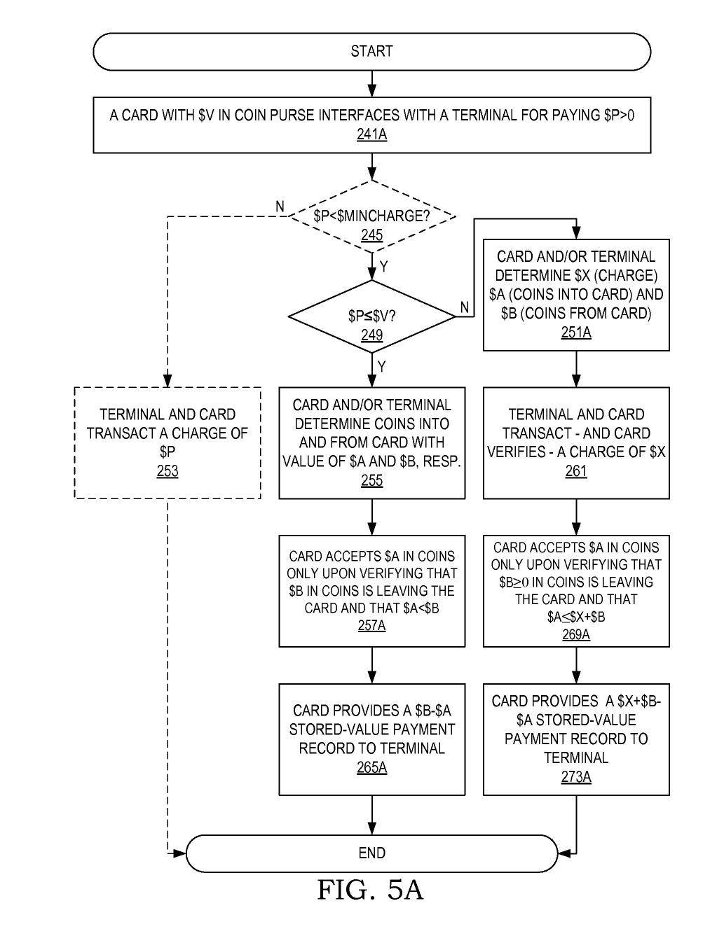

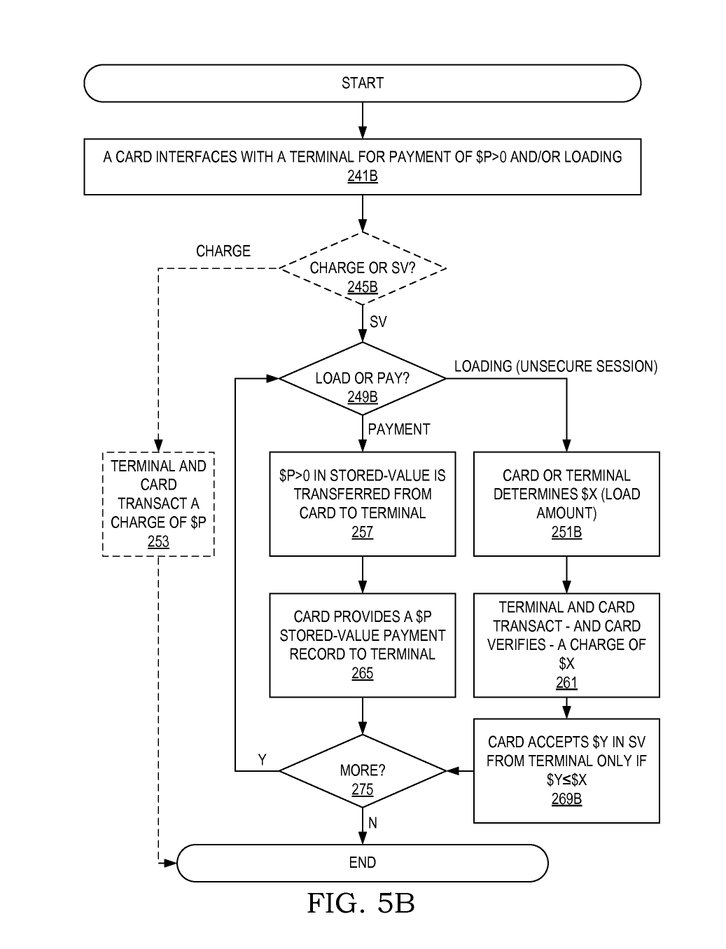

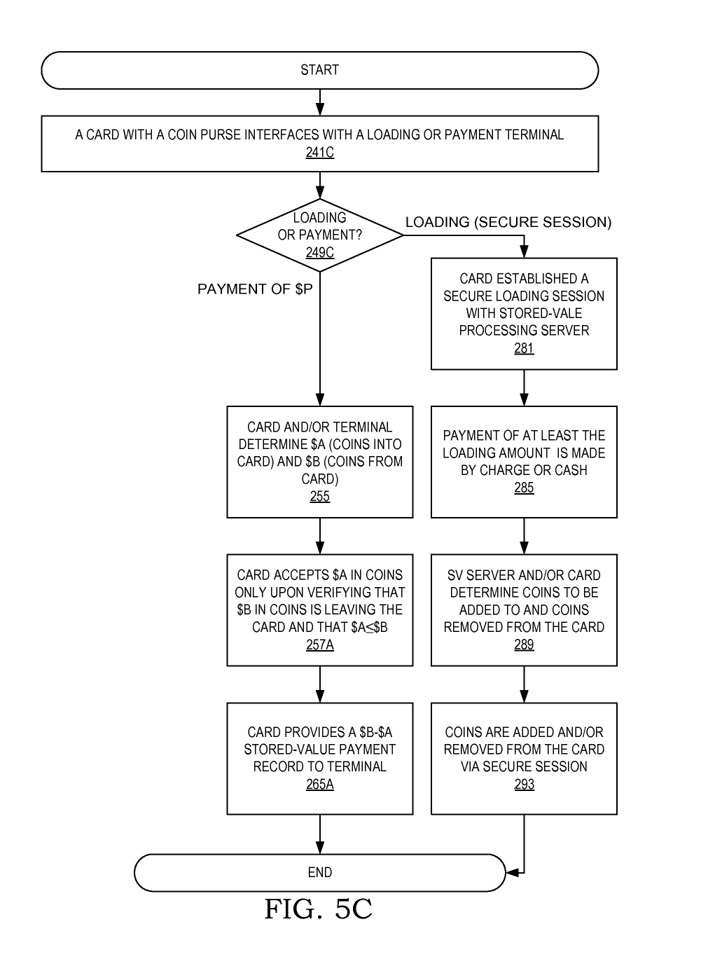

If the certificate is found valid in step 205, then step 213 verifies that the terminal time is not earlier than the card time and not later than the terminal expiration time (scenario (A) of FIG. 3). If the verification is negative, then the transaction is aborted in step 229; otherwise, the card time is optionally set according to the terminal time in step 221. Step 221 may be skipped if the card includes a real time clock (for example, if the card forms part of a mobile telephone), or if the card time is already equal to the terminal time, which may happen, for example, if the card time is actually a card date, and that date has already been properly set in a previous successful purchase transaction on the same day. In step 225 the transaction is executed, as is further described with reference to FIG. 5 below.

It will be appreciated that the process of FIG. 4 disables a stolen or tapped terminal upon the expiration of the terminal's certificate. Some cards, whose card time register 114 has not been recently updated may still cooperate with a hacked terminal whose real time clock has been set to be earlier than the certificate expiration date, but, under the assumption that cards are regularly used for making purchases at a plurality of terminals, and another assumption that the great majority of terminals are uncompromised and therefore properly maintain the card time, hacked terminals, and clones of hacked terminals, will eventually become inoperative when their certificate expires and is not further renewed by terminal certificate issuer module 192 of stored-value processing server 190.

It will also be appreciated that a hacked terminal, that is still valid, cannot harm a card by setting its time, in step 221, far into the future (which could cause the card to interpret legitimate terminals as expired terminals in step 213) because the conditions in step 213 allow setting the card time (step 221) not later than the verified expiration time, which is typically within a day or two.

### A Payment Transaction

FIG. 5 depicts a payment transaction, made by a payment card 110 at a merchant terminal 140 (FIG. 1). Some of the operations and decisions described below are executed by the merchant terminal, other may be executed by either the merchant terminal or the payment card, and still other must be executed by the payment card for security reasons; it will be noted that the payment card is considered secure and trusted, while the merchant terminal is considered untrusted in the present context. The payment transaction described below follows the logic of Charge & Change (U.S. Pat. Nos. 5,744,787 and 6,076,075).

In step 241a payment card 110 with an amount $V in its stored-value purse 122 interfaces with a merchant terminal 140 for making a payment of $P>0. Preferably but not necessarily, step 241 is carried out following the execution of the procedure of FIG. 4 where the card ascertains that merchant terminal 140 has a valid unexpired certificate. For brevity, customary methods of card-terminal mutual authentication are not described herein and in the following figures.

According to Charge & Change (U.S. Pat. Nos. 5,744,787 and 6,076,075), there is a parameter $MINCHARGE that defines a threshold suitable for performing conventional charge (credit or debit) transactions. In step 245 the payment amount $P is compared by the terminal to $MINCAHRGE, and if it is equal or greater than $MINCHARGE, then in step 253 the transaction is referred to charge handler 156 of merchant terminal 140 for conventionally charging $P to payment card 110 according to charge module 118. It will be noted that in some terminals, however, steps 245 and 253 are redundant and unused, because all payment amounts $P at that terminal are known to be below $MINCHARGE, as may be the case where merchant terminal 140 cooperates with a parking meter, ticket machine or vending machine.

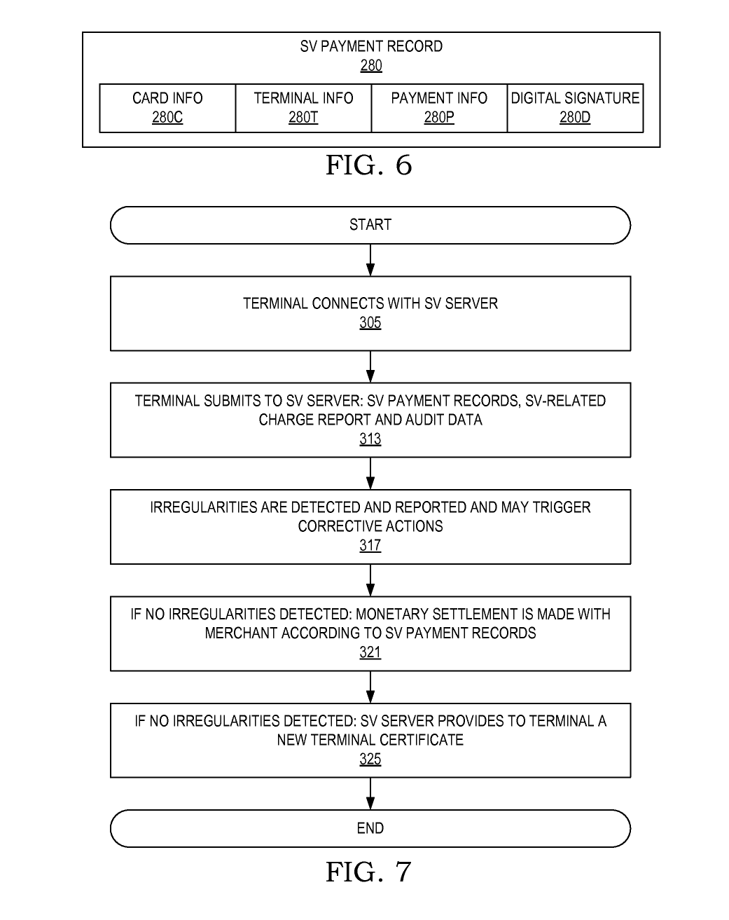

In step 249 the current stored-value balance $V that is stored in stored-value purse 122 of payment card 110 is checked, by either the terminal or the card, to determine whether it is sufficient to pay the payment amount $P. If the result of step 249 is positive, then in step 257 an amount $P, which is checked by the card to be positive to prevent a criminal from effectively infusing stored value to the card during a payment transaction, is transferred by stored-value from the card to the merchant terminal, which effectively leaves the stored-value purse 122 with a balance of $V-$P. Optionally, the stored-value transfer of $P is based on coin exchange according to U.S. Pat. Nos. 6,119,946 and 6,467,685, which provides a cost-effective audit mechanism for the stored-value transfer, as described below with reference to FIG. 5A. In step 265 the card generates and provides to the terminal a stored-value payment record for the amount $P, which is signed by the card and is verifiable by stored-value processor module 194 of stored-value processing server 190, as further described with reference to FIG. 6 below.

If in step 249 the amount $V of stored-value is insufficient for paying the amount $P, then in step 251 the card or terminal determine a charge amount $X and a change amount $Y. According to Charge & Change described in U.S. Pat. Nos. 5,744,787 and 6,076,075, $X normally equals the $MINCHARGE parameter mentioned above, but can be set also to a larger value determined by operational rules programmed into stored-value handler 152 of merchant terminal 140 or stored-value purse 122 of payment card 110. $Y, the change amount, is calculated, by the terminal or by the card, as $X-$P.

In step 261 an amount of $X is charged to the card by charge handler 156 of merchant terminal 140 in cooperation with charge module 118 of payment card 110 and the card verifies, via charge module 118, that the payment of $X has been successful. Then, in step 269, the stored-value purse 122 of payment card 110 agrees to accept from stored-value handler 152 of merchant terminal 140 a net stored-value amount of $Y only if $Y≦$X; this stored-value transfer ends up with the stored-value purse 122 containing $V+$Y. Optionally, the stored-value transfer is based on coin exchange according to U.S. Pat. Nos. 6,119,946 and 6,467,685, which provides a cost-effective audit mechanism for the stored-value transfer. Finally, the card calculates $X-$Y, i.e. the amount of charge less the amount of stored value received as change from the terminal, and generates and provides to the terminal a stored-value payment record for $X-$Y that is signed and/or encrypted by the card and is verifiable by stored-value processor module 194 of stored-value processing server 190, as further described with reference to FIG. 6 below.

It will be noted that while the terminal may do all or part of the decisions for determining $P, $X and $Y, the card exclusively and strictly controls the following operations:
The card will accept a net amount $Y in stored-value only upon verifying the successful completion of an online or offline charge for $X≧$Y (step 269). This prevents a hacker from using a hacked merchant terminal to infuse large amounts of stored-value into a card to be spent elsewhere, and also makes adding stored-value to the card dependent on charging a larger amount to the card, which renders such transactions unattractive for the cardholder. Additionally and preferably, $X is limited by any or both of charge handler 156 of merchant terminal 140 and stored-value purse 122 of payment card 110 so that Charge & Change transactions are limited to a relatively small amount, say equal to $MINCHARGE or not more than twice of $MINCHARGE, which further restricts the damage and the criminal motivation for using a hacked merchant terminal for adding value to a card to be spent in other terminals for purchases.
Amounts charged to the card by a terminal (such as $X in this case), are presumed to be known by charge module 118 of payment card 110 (FIG. 1) in both online and offline transactions, according to the smart card-based charge (e.g. credit or debit) scheme that participates in payment system 100 of FIG. 1. For example, if the charge scheme is based on the EMV standard, then the charge amount is known to the card according to §15.4 (offline charges) and §17.4 (offline charges) of Common Payment Application Specification, Version 1.0 issued by EMVCo., LLC in December 2005.
The communication between charge module 118 and stored-value purse 122 of payment card 110 so that stored-value purse 122 is aware of successful charge of $X by charge module 118, can be made in various ways, for example by storing a message accessible to card microprocessor 126 within payment card 110, or by storing a message signed by charge module 118 in merchant terminal 140.
The card generates and provides a signed and/or encrypted stored-value payment record (step 273 and step 265) for an amount of $X (the charge amount) less $Y (the change amount), or $P (the positive received stored-value amount), all values directly known to the card. Hence, the stored-value payment record that is signed and/or encrypted by the card submitted by the merchant terminal upon settlement for determining the amount paid by stored-value processing server 190 to the merchant cannot be arbitrarily determined by the merchant terminal for claiming excessive stored-value related amounts upon settlement. This highly restricts the damage and the criminal motivation of a merchant using a hacked merchant terminal for claiming excessive stored-value related amounts upon settlement.

### The Use of Coins for Audit

The optional use of coins, each coin having a denomination and unique serial number, for representing stored-value, as described in U.S. Pat. Nos. 6,119,946 and 6,467,685, allows stored-value processor module 194 of stored-value processing server 190 to effectively and quickly identify compromised terminals and cards that have cooperated with such terminals, by such devices being detected as focal points that supply bogus coins (such coins are identified by bearing duplicate or unissued serial numbers). Once a suspect terminal or card is spotted, an investigation will identify the merchant/cardholder, will immediately lead to termination of supply of fresh certificates to compromised terminals, and serves as a major deterrent against merchant and cardholder crime.

If a coin-based stored-value is used, then the two stored-value transfer transactions in FIG. 5, in steps 257 and 269, then use coins for moving $P from the card or $Y from the terminal to the card, respectively. In both cases, coins of different denominations may move in both directions, and only the net amount of transfer, i.e. $P or $Y, which is well known by the card, serves for determining the transaction amount reported within the stored-value payment record that is provided by the payment card to the merchant terminal.

A detailed discussion on using the present innovation within a coin-based stored-value system is brought below with reference to FIG. 5A.

### The Stored-Value Settlement Scheme

The stored-value payment transaction included in FIG. 5 ends up with a stored-value payment record for $P or $X-$Y, recorded at the merchant terminal. It will be appreciated that a proper terminal will calculate $X-$Y=$P, so, in both cases, the actual payment amount $P is registered within the payment records accumulated by the merchant terminal, as a basis for further stored-value related settlement. A detailed scheme for settlement based on such transaction records, where the records are aggregated by card brands and merchant fees are calculated per brand, is described in U.S. Pat. No. 6,065,675 that is incorporated herein by reference. The process of FIG. 5 ensures that the payment records are generated and signed by the respective cards, so that no merchant terminal can generate fake stored-value payment records. Obviously, a compromised terminal can submit duplicates of legitimate payment records, but since each record is unique (see reference below to FIG. 6), such duplicates will be immediately spotted by stored-value processor module 194 of stored-value processing server 190, avoiding any harm and highly deterring would-be criminals from such initiatives.

A Payment Transaction within a Coin-Based Stored-Value System

The discussion with reference to FIG. 5 above mentioned the optional use of coins for representing stored-value, according to U.S. Pat. Nos. 6,119,946 and 6,467,685. The use of serialized coins of different denomination for representing stored value offers cost effective audit mechanism that is also beneficial for the present innovation. The present discussion with reference to FIG. 5A teaches how the mechanism of FIG. 5 is further adapted for implementations that use coin-based stored-value.

FIG. 5A depicts a payment transaction, made by a payment card 110 at a merchant terminal 140 (FIG. 1). Some of the operations and decisions described below are executed by the merchant terminal, other may be executed by either the merchant terminal or the payment card, and still other must be executed by the payment card for security reasons; it will be noted that the payment card is considered secure and trusted, while the merchant terminal is considered, in the present context, untrusted. The payment transaction described below follows the logic of Charge & Change (U.S. Pat. Nos. 5,744,787 and 6,076,075) and coin-based audit (U.S. Pat. Nos. 6,119,946 and 6,467,685) all incorporated herein by reference.

In step 241A a payment card 110 with an amount $V, represented by coins, in its stored-value purse 122 interfaces with a merchant terminal 140 for making a payment of $P. Preferably but not necessarily, step 241 is carried out following the execution of the procedure of FIG. 4 where the card ascertains that merchant terminal 140 has a valid unexpired certificate.

According to Charge & Change (U.S. Pat. Nos. 5,744,787 and 6,076,075), there is a parameter $MINCHARGE that defines a threshold suitable for performing conventional charge (credit or debit) transactions. In step 245 the payment amount $P is compared by the terminal to $MINCAHRGE, and if it is equal or greater than $MINCHARGE, then in step 253 the transaction is referred to charge handler 156 of merchant terminal 140 for conventionally charging $P to payment card 110 according to charge module 118. It will be noted that in some terminals, however, steps 245 and 253 are redundant and unused, because all payment amounts $P at that terminal are known to be below $MINCHARGE, as may be the case where merchant terminal 140 cooperates with a parking meter, ticket machine or vending machine.

In step 249 the current stored-value balance $V that is stored in stored-value purse 122 of payment card 110 is checked, by either the terminal or the card, to determine whether it is sufficient to pay the payment amount $P.

If the result of step 249 is positive, then in step 255 the amount $P is processed by either stored-value purse 122 of payment card 110 or stored-value handler 152 of merchant terminal 140, to determine the coins that need to be transferred from the card to the merchant terminal (as taught by step 131-1 of FIG. 13 in U.S. Pat. Nos. 6,119,946 and 6,467,685) and whose total value is now calculated by stored-value purse 122 as $B; and to determine the coins that need to be transferred from the merchant terminal to the card (as taught by step 131-3 of FIG. 13 in U.S. Pat. Nos. 6,119,946 and 6,467,685) and whose total value is now calculated by stored-value purse 122 as $A.

In step 257A the card sends to the terminal the coins determined in step 255 and whose total value is $B and agrees to receive from the merchant terminal the coins determined in step 255 and whose total value is $A only upon verifying that $A<$B, i.e. that no effective increase of the total amount of stored-value within stored-value purse 122 can happen during a purchase transaction; otherwise the card refuses the stored-value transfer into the card or aborts the transaction. If the card controls the calculation and execution of coin exchange, then preferably the card will first send coins to the terminals before accepting coins from the terminal, or otherwise use a coin-exchange protocol that aborts a coin exchange transaction unless the coins are exchanged as decided by the card. This prevents a hacker of the merchant terminal, even if the merchant terminal calculates the coins to be exchanged between a card and the merchant terminal, from exploiting the coin exchange mechanism for effectively infusing fake stored-value into the card.

In step 265A the card provides to the terminal a payment record for the amount of $B-$A, which represents the net amount of stored value transferred from the card to the merchant terminal as calculated by the card. The payment record is signed and/or encrypted by the card and is verifiable upon settlement by stored-value processor module 194 of stored-value processing server 190, as further described with reference to FIG. 6 below.

If in step 249 the amount $V of stored-value is insufficient for paying the amount $P, then in step 251A the amounts $P, $V are processed by either stored-value purse 122 of payment card 110 and/or stored-value handler 152 of merchant terminal 140, to determine the charge amount $X (as in step 251 of FIG. 5); the coins that need to be transferred from the card to the merchant terminal whose total value is now calculated by stored-value purse 122 as $B; and the coins that need to be transferred from the merchant terminal to the card and whose total value is now calculated by stored-value purse 122 as $A. The respective coin transfers in the context of a charge $X are taught by columns 14-15 of U.S. Pat. No. 6,119,946.

In step 261 an amount of $X is charged to the card by charge handler 156 of merchant terminal 140 in cooperation with charge module 118 of payment card 110 and the card verifies, via charge module 118, that the payment of $X has been successful.

In step 269A the card sends to the terminal the coins determined in step 251A and whose total value is $B and agrees to receive from the merchant terminal the coins determined in step 251A and whose total value is $A only upon verifying that $A≦$X+$B, i.e. that no effective increase of the total amount of stored-value within stored-value purse 122 can happen behind the amount $X charged to the card during a Charge & Change transaction. This prevents a hacker of the merchant terminal, even if the merchant terminal calculates the coins to be exchanged between card and the merchant terminal, from exploiting the coin exchange mechanism for effectively infusing fake stored-value into the card.

In step 273A the card provides to the terminal a payment record for the amount of $X+$B−$A, which represents the net amount of charge+stored-value transferred from the card to the merchant terminal as calculated by the card. The payment record is signed by the card and is verifiable by stored-value processor module 194 of stored-value processing server 190, as further described with reference to FIG. 6 below.

### Unsecure Loading at a Payment Terminal

FIG. 5B describes a session of payment of $P and/or loading at an untrusted terminal. In step 241B a card interfaces with a payment terminal for making a payment of $P, wherein $P has been determined by an input received from a human or automatic merchant. In optional step 245B it is determined, either automatically by the payment amount or manually according to an input received from the cardholder or merchant, whether the payment is to be made by charge, in which case the payment is charged conventionally in step 253. In step 249B it is determined whether the next step will initiate a payment or a load transaction, for example a load transaction may be necessary if the current balance in the purse is smaller than $P, or if the cardholder wishes to load value for future uses. If payment has been decided in step 249B, then in step 257 a net positive amount $P of stored-value is transferred from the card to the terminal (either using coins or any other form of stored-value), and in step 265 the card provides a signed and/or encrypted $P payment record to the terminal. In step 275 an input received by the terminal from the cardholder may indicate that the cardholder is interested in another transaction, for example in order to manually load additional stored-value onto the card for future use, in which case the procedure moves back to step 249B.

If in step 249B a loading is selected, then the procedure moves to step 251B for determining the load amount $X, for example according to an input received from the cardholder. Under the scenario of FIG. 5B, it is presumed that the load session is unsecured, i.e. it is not completed via a secure session between payment card 110 and stored-value processing server 190 (see FIG. 1) where merchant terminal 140 serves merely as a communication conduit. In step 261 the card pays $X at the terminal by charge and verifies that payment, which can be made online or offline, via charge module 118 of payment card 110 (FIG. 1). In step 269B the card accept an amount $Y of stored-value into stored-value purse 122, only upon verifying that $Y is either equal to $X, or maybe slightly smaller if a loading fee is applied. In step 275 the terminal receives an input from the cardholder whether to conclude the session or move to step 249B for another transaction, for example making a purchase with the just-loaded stored-value.

### Secure Loading of Coins

FIG. 5C depicts usage modes of a coin purse that can be loaded via a secure session between stored-value purse 122 of payment card 110 and stored-value processing server 190, and further make a stored-value coin purchase at a merchant terminal 140.

In step 241C and step 249C the cardholder selects whether to access a loading terminal for loading stored-value into the card or a payment terminal for paying with the card. A “loading terminal” herein is any communication device that can provide data communication between payment card 110 and stored-value processing server 190 such as a merchant terminal or manned loading kiosk (that may also accept cash for loading), a personal computer, a mobile telephone or an automatic teller machine (ATM). If a loading transaction has been selected, then in step 281a secure loading session is established between payment card 110 and stored-value processing server 190. In step 285 payment of Te loading amount, optionally with the addition of a service fee, is paid by either charging the card, or charging another card, or paying with cash, according to the nature of the loading terminal. In step 289 the payment card 110 or stored-value processing server 190 calculates the coins that need to move into and from coin stored-value purse 122, and in step 293 the coins are actually moved still under the secure session established in step 281.

It will be noted that is the loading session of steps 281-293, that card does not need to (but still may) supervise the coin flow, because both payment card 110 and stored-value processing server 190 are trusted and the loading session between them is made via a secure communication session.

If in step 241 and step 249 the cardholder selects to make a payment of $P at an untrusted merchant terminal, then in step 255 the card an/or merchant terminal calculate and determine the coins than need to move from the merchant terminal to the card and whose total value is $A, and the coins that need to move from the card to the merchant terminal and whose total value is $B. In step 257A the card sends to the terminal the coins determined in step 255 and whose total value is $B and agrees to receive from the merchant terminal the coins determined in step 255 and whose total value is $A only upon verifying that $A<$B, i.e. that no effective increase of the total amount of stored-value within stored-value purse 122 can happen during a purchase transaction; otherwise the card refuses the stored-value transfer into the card or aborts the transaction. If the card controls the calculation and execution of coin exchange, then preferably the card will first send coins to the terminals before accepting coins from the terminal, or otherwise use a coin-exchange protocol that aborts a coin exchange transaction unless the coins are exchanged as decided by the card. This prevents a hacker of the merchant terminal, even if the merchant terminal calculates the coins to be exchanged between a card and the merchant terminal, from exploiting the coin exchange mechanism for effectively infusing fake stored-value into the card.

It will be noted that under the procedure of FIG. 5C the card does not necessarily include a charge function, since loading of stored-value may be made, in some embodiments, by charging another card or by paying with cash. The present embodiment may be attractive, for example, for stored-value cards loaded by parents and used by children.

### The Stored-Value Payment Record

As discussed above with reference to FIG. 5, a stored-value payment transaction ends up at either step 265 or step 273, with the card generating and sending to the terminal a stored-value payment record for the amount of either $P or $X-$Y, respectively. FIG. 6 illustrates the content of such stored-value payment record 280. The payment record is preferably represented by a text string that can be read and interpreted by stored-value handler 152 of merchant terminal 140. The text string includes four fields: card information 280C, terminal information 280T, payment information 280P and digital signature 280D. Card information 280C identifies the payment card 110 by conventional data, such as card number and card issuer. Terminal information 280T identifies the terminal by terminal ID 200T retrieved by the card from terminal certificate 200. Payment information 280P includes either $P of step 265 or $X-$Y of step 273 of FIG. 5; it preferably also includes the transaction time assumed to be equal to the terminal time received in step 201 of FIG. 4, and possibly also a transaction serial number received from the terminal. It also includes the particulars of a charge transaction for $X, if such transaction has been executed in step 261 of FIG. 5. Digital signature 280D is generated by stored-value purse 122 of payment card 110 with respect to the content of fields 280C, 280T, and 280P, which is verifiable by stored-value processing server 190 upon settlement.

### Stored-Value Settlement

FIG. 7 describes the settlement procedure, periodically initiated by merchant terminal 140 by connecting to stored-value processing server 190 via network 170. Typical frequency of such settlements is once in a day or two, preferably during idle time at night, or as needed. The frequency of settlement is predetermined by stored-value processing server 190, which affects the expiration time of the terminal certificate 200 provided by stored-value processing server 190 to the terminal during settlement. It will be noted that another settlement session may be made by merchant terminal 140 by connecting with charge processing server 180 for conventionally settling charges made in step 253 of FIG. 5.

In step 305 merchant terminal 140 connects with stored-value processing server 190 for settlement. In step 313 the terminal reports to stored-value processing server 190 all stored-value payment records 280 recorded in step 265 or step 273 of FIG. 5; all charges made in the context of Charge & Change in step 261 of FIG. 5; and audit data. All the reported information relates to transactions made since the previous stored-value settlement, and the data is reset on the merchant terminal toward the next busyness cycle. The Charge & Change charges made in step 261 are reported either separately or are included in the payment information 280P of stored-value payment record 280, as described above. The audit data is preferably but not necessarily in the form of coins that are exchanged between stored-value processor module 194 of stored-value processing server 190 for resetting the stored-value handler 152 to its designated priming amount toward the next business cycle, as taught by U.S. Pat. Nos. 6,119,946 and 6,467,685.

In step 317 the stored-value processor module 194 of stored-value processing server 190 compiles the received audit data, charge transactions of step 261 and stored-value payment records 280 to identify irregularities. One type of irregularity is a mismatch between the monetary value of the total of all stored-value payment records 280, the total amount of charges of step 261, and the (positive or negative) amount of stored-value needed to reset the stored-value handler 152 of merchant terminal 140 to its priming amount (see U.S. Pat. Nos. 5,744,787 and 6,076,075). Another type of irregularity, in a system that implements a coin-based audit system according to U.S. Pat. Nos. 6,119,946 and 6,467,685, is the detection of coins having duplicate or unissued serial numbers. Still another type of regularity is identifying a stored-value payment record 280 that is not properly signed, not within the current payment time period, a duplicate of another stored-value payment record, or a payment record of another merchant terminal. If irregularities are detected, they are reported and may trigger human investigation, decision, intervention and corrective action. If no irregularities are detected in step 317, then in step 321 the merchant's bank account is credited for the total of stored-value payment records 280, from which a fee is deducted, possibly according to the card brands, as disclosed in U.S. Pat. No. 6,065,675.

If no irregularities have been detected in step 317, then in step 325 terminal certificate issuer module 192 of stored-value processing server 190 will issue a fresh terminal certificate 200 having an expiration time according to the next predicted settlement time, and the terminal will be ready for the next business cycle.

While the invention has been described with respect to a limited number of embodiments, it will be appreciated by persons skilled in the art that the present innovation is not limited by what has been particularly shown and described herein. Rather the scope of the present innovation includes both combinations and sub-combinations of the various features described herein, as well as variations and modifications which would occur to persons skilled in the art upon reading the specification and which are not in the prior art.

What is claimed is:

1. A method executed by a card while making a stored-value payment transaction at a merchant terminal, the method comprising:
interfacing with the merchant terminal; and
accepting a positive first amount of stored-value into the card only upon confirming that a corresponding second amount, that is not smaller than said first amount, is paid by the card at the merchant terminal.

2. The method of claim 1, wherein said second amount is paid by charge.

3. The method of claim 1, operating within a coin-based stored-value system for a payment transaction that does not include a charge transaction, the payment transaction then consists of:
a first group of zero or more coins designated to flow from the merchant terminal to the card, and
a second group of one or more coins designated to flow from the card to the merchant terminal;
wherein said first amount equals said first group's total value and said second amount equals said second group's total value.

4. The method of claim 1, operating within a coin-based stored-value system in a payment transaction that includes both a charge transaction and a stored-value transaction that consists of:
a first group of one or more coins designated to flow from the merchant terminal to the card, and
a second group of zero or more coins designated to flow from the card to the merchant terminal;
wherein:
said first amount equals said first group's total value; and
said second amount equals the sum of:
said second group's total value, and
said charge transaction's value.

5. The method of claim 1, further comprising:
calculating a payment amount by subtracting said first amount from said second amount, and
providing to the merchant terminal a verifiable payment record for said payment amount.

6. The method of claim 1, further comprising:
verifying the validity of a terminal certificate received from the merchant terminal, and aborting the stored-value payment transaction if said verifying is negative; and
if said verifying is positive:
reading a card time from a time register of the card,
receiving a terminal time from the merchant terminal,
retrieving a terminal expiration time from said terminal certificate,
checking whether said terminal time is both not smaller than said card time and not greater than said terminal expiration time, and
aborting the payment transaction if said checking is negative.

7. The method of claim 6, further comprising: if said checking is positive, then setting said card time in said time register according to said terminal time.

8. A method executed by a card while making a stored-value payment transaction at a merchant terminal, the stored-value being represented by digital coins, each coin having a serial number and a denomination from a plurality of denominations, the method comprising:
interfacing with the merchant terminal; and
accepting from the merchant terminal a positive number of coins whose total value equals a first amount, only upon confirming that a corresponding second amount, that is not smaller than said first amount, is paid by the card at the merchant terminal.

9. The method of claim 8, in a payment transaction that includes a charge transaction and a transfer of zero or more coins from the card to the merchant terminal, wherein said second amount equals the sum of said charge transaction's value and said zero or more coins' total value.

10. The method of claim 8, in a payment transaction that does not include a charge transaction and does include a transfer of one or more coins from the card to the merchant terminal, wherein said second amount equals said one or more coins' total value.

11. A payment card comprising:
a microprocessor;
a terminal interface for selectably interfacing with a selectable merchant terminal for making a payment transaction;
a charge module cooperating with said microprocessor for charging a remote account; and
a stored-value purse for storing stored-value, cooperating with said microprocessor for moving selectable amounts of stored-value between the payment card and a merchant terminal via said terminal interface, wherein the payment card is operative, while interfacing with a selected merchant terminal, to accept a positive first amount of stored-value only upon confirming that a corresponding second amount, that is not smaller than said first amount, is paid by the payment card at said selected merchant terminal.

12. The payment card of claim 11, in a payment transaction that includes both charge and stored-value transactions; said first amount is a net amount of stored-value received by said stored-value purse, and said second amount is paid by said charge module.

13. The payment card of claim 11, operating within a coin-based stored-value system in a payment transaction that does not include a charge transaction, said payment transaction then consists of:
a first group of zero or more coins designated to flow from the merchant terminal to said purse, and
a second group of one or more coins designated to flow from said purse to the merchant terminal;
wherein said first amount equals said first group's total value and said second amount equals said second group's total value.

14. The payment card of claim 11, operating within a coin-based stored-value system in a payment transaction that includes both charge and stored-value transactions, wherein said first amount is the total value of coins received by said stored-value purse from said selected merchant terminal, and said second amount equals the sum of:
a charge amount paid by said charge module at said selected merchant terminal, and
the total value of coins transferred from said stored-value purse to said selected merchant terminal.

15. The payment card of claim 11, further operative to calculate a payment amount by subtracting said first amount from said second amount, and provide to said selected merchant terminal a verifiable payment record for said payment amount.

16. The payment card of claim 11, further comprising a card time register, and wherein said payment card is further operative to:
verify the validity of a terminal certificate received from said selected merchant terminal;
abort a transaction if said verify is negative; and
if said verify is positive:
read a card time from said card time register,
receive a terminal time from said selected merchant terminal,
retrieve a terminal expiration time from said terminal certificate,
check whether said terminal time is both not smaller than said card time and not greater than said terminal expiration time, and
abort the transaction if said check is negative.

17. The payment card of claim 16, further operative, if said check is positive, to set said card time in said card time register according to said terminal time.

18. A merchant terminal comprising:
a card interface for communicating with payment cards;
a network interface for interfacing, via a network, with a stored-value processing server;
a terminal certificate register for storing a terminal certificate that includes a terminal ID and a terminal expiration time; and
a processor configured to:
during settlement with said stored-value processing server, renew said terminal certificate stored is said terminal certificate register, and
during interfacing with a card, present said terminal certificate to said card.

19. A method for operating a stored-processing server, the method comprising:
interfacing with a merchant terminal;
receiving terminal identification from said merchant terminal; and
if no irregularities are identified with respect to said terminal identification, then issuing a fresh terminal certificate for said merchant terminal, said terminal certificate including at least said terminal identification and a terminal expiration time, and providing said fresh terminal certificate to said merchant terminal.

20. The method of claim 19, further comprising:
if and only if no irregularities are identified, then executing stored-value settlement with said merchant terminal.
